(19) United States
(12) Patent Application Publication
(10) Pub. No.: US 2007/0174023 A1
(43) Pub. Date: Jul. 26, 2007

(54) Methods and apparatus for considering a project environment during defect analysis

(75) Inventors: Kathryn A. Bassin, Harpursville, NY (US); Paul A. Beyer, Marietta, GA (US); Linda M. Clough, South Windsor, CT (US); Sandra R. Hardman, Washington, DC (US); Deborah A. Masters, Wake Forest, NC (US); Susan E. Skrabanek, Talking Rock, GA (US); Nathan G. Steffenhagen, Eau Claire, WI (US)

Correspondence Address: IBM Corporation;Intellectual Property Law Dept. 917, 3605 Hwy. 52 North, Rochester, MN, 55901, US

(73) Assignee: INTERNATIONAL BUSINESS MACHINES CORPORATION, ARMONK, NY (US)

(21) Appl. No.: 11/340,740

(22) Filed: Jan. 26, 2006

(51) Int. Cl. G06F 11/30

(52) U.S. Cl. 702/186; 702/127; 702/182

(57) ABSTRACT

In a first aspect, a first defect analysis method is provided. The first method includes the steps of (1) while testing a software project, identifying at least one failure caused by an environment of the project; and (2) considering the effect of the project environment on the software project while analyzing the failure. Numerous other aspects are provided.

### CROSS-REFERENCE TO RELATED APPLICATIONS

The present application is related to U.S. patent application Ser. No. 11/122,799, filed May 5, 2005 and titled “METHODS AND APPARATUS FOR DEFECT REDUCTION ANALYSIS” (Attorney Docket No. ROC920040327US1), and U.S. patent application Ser. No. 11/122,800, filed May 5, 2005 and titled “METHODS AND APPARATUS FOR TRANSFERRING DATA” (Attorney Docket No. ROC920040336US1) both of which are hereby incorporated by reference herein in their entirety.

### FIELD OF THE INVENTION

The present invention relates generally to computer systems, and more particularly to methods and apparatus for considering a project environment during defect analysis.

### BACKGROUND

Conventional methods, apparatus and systems for analyzing defects (e.g., in software related to a project), such as Orthogonal Defect Classification (ODC), may focus on problems with code or documentation. However, such conventional methods and apparatus do not consider the role of a system environment while analyzing such defects. Defects or failures related to and/or caused by system environment may be significant, and therefore, may introduce unnecessary cost to the project. Accordingly, improved methods, apparatus and systems for defect analysis are desired.

### SUMMARY OF THE INVENTION

In a first aspect of the invention, a first defect analysis method is provided. The first method includes the steps of (1) while testing a software project, identifying at least one failure caused by an environment of the project; and (2) considering the effect of the project environment on the software project while analyzing the failure.

In a second aspect of the invention, a first apparatus is provided. The first apparatus includes (1) an ODC analysis tool; and (2) a database coupled to the ODC analysis tool and structured to be accessible by the ODC analysis tool. The apparatus is adapted to (a) receive data including at least one failure caused by an environment of a software project, the failure identified while testing the software project; and (b) consider the effect of the project environment on the software project while analyzing the failure.

In a third aspect of the invention, a first system is provided. The first system includes (1) a defect data collection tool; (2) an ODC analysis tool; and (3) a database coupled to the defect data collection tool and the ODC analysis tool and structured to be accessible by the ODC analysis tool. The system is adapted to (a) receive in the database from the defect data collection tool data including at least one failure caused by an environment of a software project, the failure identified while testing the software project; and (b) consider the effect of the project environment on the software project while analyzing the failure. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system for performing defect data analysis in accordance with an embodiment of the present invention.

FIG. 2 illustrates a method of defect data analysis in accordance with an embodiment of the present invention.

### DETAILED DESCRIPTION

The present invention provides improved methods, apparatus and systems for analyzing defects. More specifically, the present invention provides methods, apparatus and systems for analyzing defects or failures which consider system environment. For example, the present invention may provide an improved ODC which may focus on failures caused by a problem with system environment while analyzing defects of a software project. The improved ODC may include a data structure adapted to analyze failures caused by system environment. In this manner, the present invention may consider the effect of system environment while analyzing software project defects. Further, the present invention may provide metrics and/or reports based on such defect analysis which considers the system environment. In this manner, the present invention provides improved methods, apparatus and systems for analyzing defects.

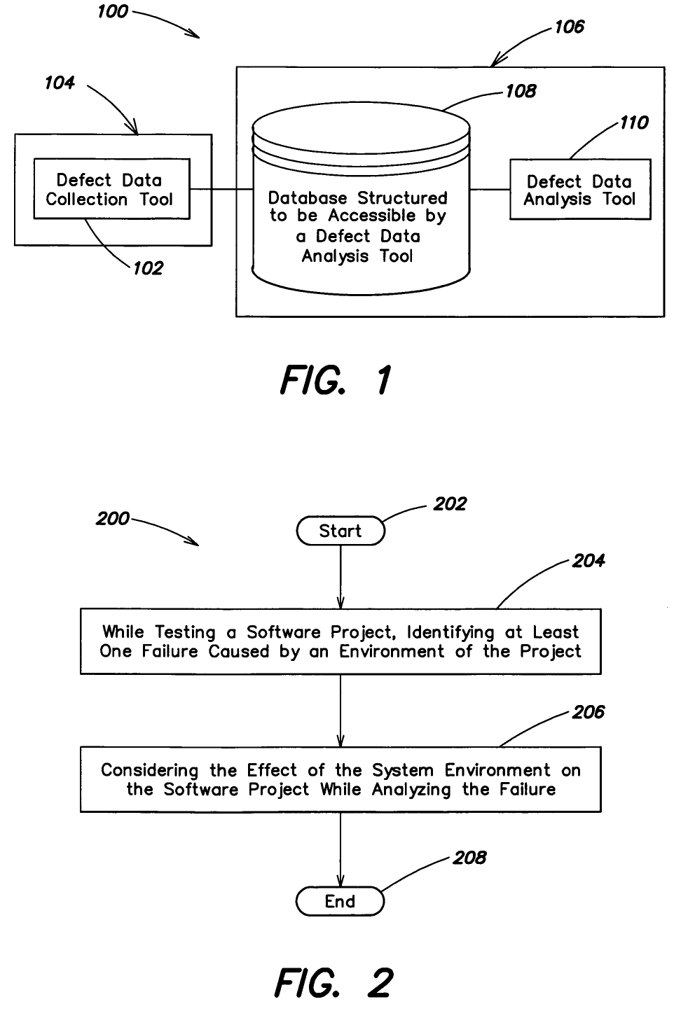

FIG. 1 is a block diagram of system 100 for performing defect data analysis in accordance with an embodiment of the present invention. With reference to FIG. 1, the system 100 for performing defect data analysis may include a defect data collection tool 102. The defect data collection tool 102 may be included in a software project 104. The environment of the software project 104 may be defined by hardware employed thereby, a network topology employed thereby, software executed thereby and/or the like. The defect data collection tool 102 may be adapted to test the software project 104. For example, the defect data collection tool 102 may be adapted to test software executed by the software project 104, supporting documents related to the software project 104 and/or the like. The defect data collection tool 102 may be adapted to collect defect data during testing of the software project 104. While testing the software project 104, one or more of the defects or failures collected may be identified as being caused by an environment of the project 104.

The system 100 for performing defect data analysis may include infrastructure 106 for performing defect data analysis coupled to the defect data collection tool 102. The infrastructure 106 for performing defect data analysis may include a database 108 coupled to a defect data analysis tool 110. The database 108 may be adapted to receive and store the defect data collected by defect data collection tool 102 during testing of the software project 104. Some of the collected defect data may be identified as failures caused by an environment of the project 104. Further, the database 108 may be adapted (e.g., with a schema) to be accessible by the defect data analysis tool 110. In this manner, the defect data analysis tool 110 may be adapted to access the defect data stored in the database 108 and perform defect data analysis on such defect data. In contrast to conventional systems, the system 100 may consider software project environment while performing defect data analysis. For example, the system 100 may consider the effect of the project environment on failures or defects collected during software system testing. In some embodiments, the defect data analysis tool 110 may be adapted to perform improved Orthogonal Defect Classification (ODC) like an improved Defect Reduction Methodology (DRM) on the defect data. DRM is described in commonly-assigned, co-pending U.S. patent application Ser. No. 11/122,799, filed on May 5, 2005 and titled “METHODS AND APPARATUS FOR DEFECT REDUCTION ANALYSIS” (Attorney Docket No. ROC920040327US1), and U.S. patent application Ser. No. 11/122,800, filed on May 5, 2005 and titled “METHODS AND APPARATUS FOR TRANSFERRING DATA” (Attorney Docket No. ROC920040336US1), both of which are hereby incorporated by reference herein in its entirety. In contrast to conventional ODC, during the improved ODC, the defect data analysis tool 110 may access the collected data, some of which may have been identified as failures caused by an environment of the project 104. Further, during the improved ODC, the defect data analysis tool 110 may consider project environment while analyzing the defect data. The defect data analysis tool 110 may be adapted to include a set of definitions, criteria, processes, procedures, reports and/or the like to produce a comprehensive assessment of defects related to system environment collected during software project testing 104. A depth of analysis of such assessment of environment defects may be similar to that of the assessment provided by conventional ODC for defects related to code and/or documentation related thereto.

FIG. 2 illustrates a method of defect data analysis in accordance with an embodiment of the present invention. With reference to FIG. 2, in step 202, the method 200 begins. In step 204, at least one failure caused by an environment of the project may be identified while testing a software project. For example, the defect data collection tool 102 may identify a failure as caused by or related to the software project environment. Such a failure may be identified using the “Target” ODC/DRM field (described below).

In step 206, the effect of the project environment on the software project is considered while analyzing the failure. For example, the defect data analysis tool 110 may employ the set of definitions, criteria, processes and/or procedures to analyze the at least one failure caused by or related to the system environment while analyzing the defect data. Additionally, the defect data analysis tool 110 may generate a report based on the failure analysis. Such report may provide an assessment of the effect of project environment on the software project during testing.

Thereafter, step 208 may be performed. In step 208, the method ends. Through use of the present methods, project environment may be considered while performing defect data analysis, such as an improved ODC like the improved DRM. The improved ODC may be similar to conventional ODC. However, in contrast to conventional ODC, the improved ODC may include and apply an extension which considers project environment defects.

For example, the improved ODC/DRM schema may be an updated or altered version of the conventional ODC schema. In this manner, the improved ODC/DRM may provide meaningful, actionable insight into defects that occur in test due to environment problems or failures. One or more ODC/DRM fields may be added and/or updated as follows. For example, the improved ODC/DRM may include classification changes compared to the conventional ODC. ODC/DRM field “Target” may be updated to include value “Environment” so the improved ODC/DRM may assess environment defects (although field Target may be updated to include a larger amount of and/or different potential values). Additionally, ODC/DRM field “Artifact Type”, which may describe a nature of a defect fix when Target=Environment, is updated to include values “Configuration/Definition”, “Connectivity”, “System/Component Completeness”, “Security Permissions/Dependencies”, “Reboot/Restart/Recycle”, “Capacity”, “Clear/Refresh”, and “Maintenance” fields. The Configuration/Definition value may indicate a failure may be resolved by changing how the environment is configured/defined. In this manner, changes may be made to scripts required to bring up the environment, to account for a missed table entry and/or the like as required. The Connectivity value may indicate a failure may be resolved by correcting/completing a task that defines links between and across a system or systems employed by the software project which was previously performed incorrectly/incompletely. For example, incompatibility of system component versions may be resolved by installing an appropriate version of or upgrading a connectivity component. Additionally or alternatively, an incorrectly-defined protocol between components of the system may be corrected. The System/Component Completeness value may indicate a particular functional capability has been delivered to test after test entry in a code drop, but when a test is performed, the functional capability is not present in the component or system, and consequently, such functional capability should be added/corrected/enabled to resolve the failure. Such an error may occur in the build to the integration test (rather than during configuration). In contrast to an individual component test build requirement that fails, which is considered a build/package code related defect, the build problem described above may be a result of a system level build error (e.g., no individual component is responsible for the problem and the problem only occurs in the integrated environment).

The Security Permissions/Dependencies value may indicate a lack of system access caused a failure. For example, system access may be blocked due to a password and/or certification noncompliance, non-enabled firewall permissions, etc. Further, the Security Permissions/Dependencies value may indicate that resetting the password and/or certification noncompliance, enabling the firewall permissions and/or the like may resolve the failure. The Reboot/Restart/Recycle value may indicate that a code change may not be required to resolve a failure, the specific cause of which may not be known, but a reboot/restart/recycle of some component or process of the system 100 (e.g., to clear error conditions) may resolve the failure. The Capacity value may indicate that a failure is caused by a capacity problem, such as a component of the software system running out of drive space, the system being unable to provide enough sessions and/or the like, and such failure may be resolved by increasing capacity of the system 100. The Clear/Refresh value may indicate a failure may be resolved by cleaning up the system such that resources are reset of cleared. For example, system files/logs may require emptying, files may require dumping, etc. The Maintenance value may indicate that a failure may be resolved by bringing down the system (e.g., to install an upgrade and/or a patch (e.g., fix)). The above values for the Artifact Type field are exemplary, and therefore, a larger or smaller number of and/or different values may be employed.

DRM field “Artifact Type Qualifier” may define classifications which map to “Artifact Type” fields. For example, when Artifact Type=Configuration/Definition, options for the Artifact Type Qualifier value may be “Incorrectly Defined”, “Missing Elements”, “Confusing/Misleading Information”, “Default Taken But Inadequate”, and “Requirement/Change Unknown/Not Documented”. When Artifact Type=Connectivity, options for the Artifact Type Qualifier value may be “Incompatibility”, “Incorrectly Defined”, “Confusing/Misleading Information”, “Default Taken But Inadequate, “Missing Elements”, and “Requirement/Change Unknown/Not Documented”. When Artifact Type=System/Component Completeness, options for the Artifact Type Qualifier value may be “Missing Elements”, “Present-But Incorrectly Enabled” and “Present-But Not Enabled”. When Artifact Type=Security Dependency, options for the Artifact Type Qualifier value may be “Incorrectly Defined”, “Missing Elements”, “Confusing/Misleading Information”, “Reset or Restore”, “Permissions Not Requested”, and “Requirement/Change Unknown/Not Documented”. When Artifact Type=Reboot/Restart/Recycle, options for the Artifact Type Qualifier value may be “Diagnostics Inadequate” and “Recovery Inadequate”. When Artifact Type=Capacity, options for the Artifact Type Qualifier value may be “Incorrectly Defined”, “Missing (Default Taken)”, “Confusing/Misleading Information” and “Requirement/Change Unknown/Not Documented”. When Artifact Type=Clear Refresh, options for the Artifact Type Qualifier value may be “Diagnostics Inadequate” and “Recovery Inadequate”. When Artifact Type=Maintenance, options for the Artifact Type Qualifier value may be “Scheduled” and “Unscheduled”. However, a larger or smaller number of and/or different options may be employed when Artifact Type is Configuration/Definition, Connectivity, System/Component Completeness, Security Dependency, Reboot/Restart/Recycle, Capacity, Clear/Refresh and/or Maintenance.

Additionally or alternatively, ODC/DRM field “Source”, which may indicate a source of a failure when field Target=Environment, may be added to include the value “Failing Component/Application” (although field source may be updated to include additional and/or different values. Further, ODC/DRM field “Age” may be updated (e.g., narrowed) when field Target=Environment to only include values “Pre-existing” or “New”. Testers may employ a list of new vs. components/applications existing in the release prior to beginning test as a reference to select an appropriate “Age” for a component/application. However, field “Age” may include a larger or smaller amount of and/or different values.

Additionally or alternatively, ODC/DRM field “Impact” may be updated to include values “Installability”, “Security”, “Performance”, “Maintenance”, “Serviceability”, “Migration”, “Documentation”, “Usability”, “Reliability”, “Capability” and “Interoperability/Integration”. However, field “Impact” may include a larger or smaller amount of and/or different values.

Additionally or alternatively, a new optional ODC/DRM field “Business Process” may be defined. When collected, such a field may provide business process/function level assessment information. Further, ODC/DRM field “Open Date” is defined to indicate a date on which a defect or failure is created. Additionally, ODC/DRM field “Focus Area” is defined to store a calculated value. For example, a calculated value for a Focus Area “Skill/Training/Process” may be comprised of failures with the qualifier values “Incorrect”, “Missing”, “Incompatibility”, “Default Taken But Inadequate”, and “Permissions Not Requested”. Further, a calculated value for a Focus Area “Communication” may be comprised of failures with the qualifier value “Requirements/Change Unknown/Not Documented”. Additionally, a calculated value for a Focus Area “Component/System” may be comprised of failures with the qualifier values “Confusing/Misleading Information”, “Unscheduled”, “Diagnostics Inadequate”, “Recovery Inadequate”, “Reset or Restore”, “Present, But Incorrectly Enabled”, “Present, But Not Enabled”, “Scheduled” and “Unscheduled”. However, a calculated value for Focus Area “Skill/Training/Process”, “Communication” and/or “Component/System” may comprise failures of a larger or smaller amount of and/or different qualifier values.

The above fields of the improved DRM are exemplary. Therefore, a larger or smaller number of and/or different fields may be employed.

Another core portion of the present methods and apparatus are described below. The following information (e.g., metric and/or assessment) may be employed to provide trend/pattern interpretation so that project teams may develop action plans and/or mitigate risks identified by a DRM Assessment Process. The DRM Assessment Process may be an assessment of interim progress and risk, phase exit risk and/or future improvements. The improved DRM may include new and/or updated quality/risk metrics and instructions. Such metrics may provide insight (e.g., a quality/risk value statement) and help generate reports, which may not be created by conventional software engineering or test methodology. For example, the software system 100 may employ one or more of the following metrics. A metric indicating a number/percentage distribution of defects or failures caused by Target type may be employed. By employing such a metric, the improved DRM may enable a user to understand the relative distribution of defects or failures (whether they are related (e.g., primarily) to (1) a code/design/requirement issue; (2) an environment issue; and/or (3) a data issue). If the improved DRM determines one of these issues (e.g., Targets) represents a large portion (e.g., majority) of the total number of failures found during a test, DRM will follow the Assessment Path (described below) for that Target. If none of these Targets represent a large portion of the total number of failures found in test, the improved DRM may employ metric “Target by ‘Open Date’ ” to determine an Assessment Path to follow. Metric “Target by ‘Open Date’ ” may be employed to indicate a relative distribution of defects. Such metric may be used to determine whether defects are primarily related to or caused by (1) code/design/requirements issues (2) environment issues and/or (3) data issues. Such metric may be a trend over time. For example, if a trend of defects which are primarily related to or caused by environment issues does not decrease over time and/or represents more than about 30% of a total number of valid defects found during a software system test, additional metrics and/or variables may be considered (although a larger or smaller and/or different percentage may be employed). Assuming the trend of defects primarily related to or caused by environment issues does not decrease over time and/or represents more than about 30% of a total number of valid defects found during the software system test, such additional metrics and/or variables may be employed to yield significant insight into corrective actions to reduce future system environment failures, which may adversely impact testing.

In this manner, every assessment may start by examining a distribution of Targets to accurately and precisely identify, prioritize and address weaknesses, which may cause increased delays and/or costs during testing and eventually in production. Such increased delays and/or costs may result in customer dissatisfaction. The defects or failures caused by the software project environment (e.g., when Target=Environment) may indicate deficiencies or failures associated with assessing a project's integration quality (e.g., how to improve consumability and/or usability of the system) rather than code or design defects (e.g., defects uncovered during a test that are resolved using component/application development resources). Specifically, these weaknesses (e.g., the failures caused by the software project environment) may be the result of deficiencies in (1) Environment Setup and Configuration Processes/Procedures; (2) Skill or Training in related areas within the test/environment support organization; (3) Component/Application Maturity; and/or the like. Environment Setup and Configuration Processes/Procedures may be defined by test/environment support organizations associated with the software project. Component/Application Maturity (individually and/or collectively) may refer to maturity in terms of diagnostic capability, recoverability, usability, and other aspects of consumability as the component and/or application functions within a complex system environment. For example, when a component/application of the software project is initially released, most of a development focus to that date may by necessity be on the functional capability the component/application is intended to provide and the overall reliability of the component/application. As newly released components/applications “stabilize” over subsequent releases, the development focus may tend to shift towards areas that are not directly providing functionality, such as the ability of the component/application to (1) provide adequate diagnostic information in the event of a failure; (2) recover from failures either within the component or in other parts of the system; (3) meet “general consumability” customer expectations; (4) communicate. However, the focus may shift to a larger or smaller amount of and/or different areas. The ability of the component/application to meet “general consumability” customer expectations refers to an ease with which customers are able to acquire, install, integrate and/or use functionality of a system and each component/application of the system. The ability of the component/application to communicate may refer to the system's ability to communicate across system component/application development organizations and with test/environment support organizations (e.g., to indicate changes to design, protocols and/or interfaces that affect interactions or configuration parameters associated with the system).

The improved DRM may employ other metrics and instructions. For example, the improved DRM may generate a chart for each of a Focus Area metric by (1) Source (Failing Component/Application) field; (2) Open Date field; and/or (3) Business Process field (if applicable). A first step of a DRM environment path is Focus Area Assessment. For example, to interpret relative proportions of each Focus Area based on source components/applications, time and/or business processes, if tracked, the improved DRM may use the individual Focus Area Assessment information (described below). Collectively this information may allow optimum prioritization of corrective actions if needed. During the focus area assessment, if it is determined that any one trend dominates in only a few components/applications across the system, the improved DRM may perform the next step of the DRM environment path, Artifact Assessment (described below) for each component/application in order to provide the teams responsible for (e.g., owning) such component/application as much useful corrective information as possible. For example, to help understand what steps to take to mitigate production problems for customers, the improved DRM may compare Focus Area metric by Business Process field, if applicable. Further, if all components/applications in the system exhibit roughly the same trend(s), the improved DRM may generate information based on the Artifact Type metric by Focus Area field to understand systemically what may need to be addressed in the next software project release.

During Focus Area Assessment, to assess Interim Progress and Risk of a software project, the improved DRM may consider, for example, failures caused by or associated with skill/training/process, communication, a component/system, etc. Failures caused by or associated with focus area skill/training may indicate the failure was due to inexperience, lack of skill or knowledge on the part of the tester or the like. Addressing skills taught and/or training provided may be critical, but is ultimately a static solution that may require an ongoing focus to be effective. For example, skills taught and/or training provided may not be addressed only once, but rather should be addressed repeatedly as new personnel join an organization. Similarly, failures caused by or associated with focus area process may indicate the failure was due to inexperience, lack of skill or knowledge on the part of the tester or the like. In many cases, this information may be employed to identify process changes, which may eliminate a need for skill by describing in detail (e.g., spelling out) critical information within the procedures. However, describing critical information in detail (rather than providing skill) may not be a practical solution for every deficiency or failure, and consequently, the organization must determine an optimal balance between the two actions. In a similar manner, during Focus Area Assessment, the improved DRM may consider the above indicators to assess a Phase Exit Risk and/or a Future Improvement of the software project.

If such indicators are determined while assessing the interim progress and risk, a test organization may take these actions if this focus area may expose the project to failure during testing, thereby implementing mitigating actions quickly. Alternatively, if such indicators are determined while assessing the phase exit risk, a key question at exit time may be whether these deficiencies were addressed adequately and on a timely basis as they arose such that testing effectiveness was not compromised. Alternatively, such indicators may be determined while assessing a future improvement to the software project. Although such failures may be addressed with skill/training, when a large number of such failures occur, a request for a Wizard (e.g., an installation/configuration Wizard) may be submitted to the component/application owners. The testing organization of the software project may benefit from the Wizard. Also, the Wizard may help reduce the number of customer problems once the software project is released (e.g., in production).

Failures caused by or associated with focus area communication may indicate the failure was due to an inability of components/systems of the project to communicate with each other. Such a communication failure may be caused when design elements related to configuration settings, parameter values, link definitions, firewall settings, etc. of a single component/system or groups of components/systems are changed by the component/system owners (e.g., the group responsible for the components/systems), but the new information (e.g., the design element changes) are not documented and/or communicated to the testing organization or team. Also included under this focus area are communication failures due to a decision to delay or eliminate functionality after the test plan has been closed, which is made without advising the testing organization. In a similar manner, during Focus Area Assessment, the improved DRM may consider the above indicators to assess a Phase Exit Risk and/or a Future Improvement of the software project.

When such indicators are determined while assessing the interim progress and risk, if failures in this FOCUS AREA persist across multiple components and the trend of such failures is growing over time, such failures may have a detrimental effect on productivity and may make ensuring test effectiveness difficult. By discussing the pattern/trend provided by the improved DRM and what such pattern/trend means with components and test management teams during early stages of the software project, such teams may be encouraged to improve communication procedures within and across components of the system.

Alternatively, when such indicators are determined while assessing the phase exit risk, two critical questions may be considered at exit time (1) Was all component functionality delivered to the test organization with sufficient time for the organization to execute the test plan comprehensively?; and (2) Did changes to design elements adversely affect the test organization's ability to comprehensively execute a test plan? In addition to failure volume associated with failures in this focus area, the improved DRM may examine a trend over time to determine if these issues were pervasive throughout the phase (e.g., or were identified and addressed early). If the issues were pervasive throughout, the improved DRM may indicate the system is likely unstable from a design perspective.

Alternatively, when such indicators are determined while assessing a future improvement to the software project, discussions should take place with component/application owners to encourage the owners to improve procedures to provide communication between pertinent components/applications in the future, and to communicate changes in functional content to the testing organization on a timely basis.

Failures caused by or associated with focus area component/system may indicate the failure was due to a deficiency in an individual component/application, a group of components/applications and or the system but not in terms of their functional capability. Such failures may also include failures in an associated deliverable, such as documentation (e.g., books or integrated information including messages, diagnostics and/or the like). In this manner, a component/system failure may be identified, which typically may have been raised against a component/application but rejected or marked as an invalid defect due to a “user error”, “working as designed”, “suggestion”, etc. Because component/system failures or deficiencies relate to diagnostic or recoverability capability and/or ease of use, employing the improved DRM to correct such failures or deficiencies may impact usability of the component/application. In a similar manner, during Focus Area Assessment, the improved DRM may consider the above indicators to assess a Phase Exit Risk and/or a Future Improvement of the software project.

When such indicators are determined while assessing the interim progress and risk, because such component/system deficiencies may not directly be associated with functional capability of the component/system, such deficiencies may be assigned a lower priority than other deficiencies, and therefore, are unlikely to be addressed by the component/application owner during testing. If they surface as a high priority during the interim assessment, however, it may still be possible to make adjustments to the schedule, or mitigate them by other means.

Alternatively, when such indicators are determined while assessing the phase exit risk, because component/system failures or deficiencies are not directly associated with functional capability of the component/application, such failures or deficiencies may typically be assigned a lower priority than other deficiencies by the component/application owner. However, the component/application deficiencies may however affect productivity and/or a testing schedule of the testing organization. Further, such deficiencies may adversely affect testing effectiveness and/or comprehensiveness.

Alternatively, when such indicators are determined while assessing a future improvement to the software project, because component/application deficiencies are not directly associated with functional capability of the component/application, such deficiencies are typically assigned a lower priority by the component/application owner. However, the deficiencies or failures occurring during testing and an impact of such deficiencies or failures on testing organization productivity and testing schedule may indicate how a customer may perceive the system once in production (e.g., production failures or deficiencies may be comparable to testing failures or deficiencies).

A second step of the DRM environment path is Artifact Assessment. During Artifact Assessment, the improved DRM may generate an Artifact Type by Qualifier chart for one or more of the more error-prone components/applications, and provide such information to an appropriate software project team for a corrective action. For Artifact Type “Configuration/Definition”, a significant proportion of environment failures associated with qualifier values “Incorrect Defined”, “Missing Elements” or “Default Taken (But Inadequate)” may suggest weaknesses in Process or Skill/Training. Alternatively, for Artifact Type “Configuration/Definition”, a significant proportion of environment failures associated with qualifier values “Requirement/Change Unknown/Not Documented” may imply a deficiency in Communication. Alternatively, for Artifact Type “Configuration/Definition”, a significant proportion of environment failures associated with qualifier value “Confusing/Misleading Information” may suggest a weakness in usability of the Component/System (e.g., in some form of documentation associated therewith).

For Artifact Type “Connectivity” a significant proportion of environment failures associated with qualifier values “Incorrectly Defined”, “Missing Elements” and/or “Incompatibility” may suggest a weakness in Process or Skill/Training. For Artifact Type “Connectivity” a significant proportion of environment failures associated with qualifier value “Requirement/Change Unknown/Not Documented” may imply a deficiency in Communication. Similarly, for Artifact Type “Connectivity” a significant proportion of environment failures associated with qualifier value “Confusing/Misleading Information” may suggest weaknesses in usability of the Component/System (e.g., in some form of documentation associated therewith).

For Artifact Type “System/Component Completeness”, a significant proportion of environment failures associated with any of the qualifier options (e.g., “Missing Elements, “Present-But Incorrectly Enabled” and “Present-But Not Enabled”) may indicate a deficiency in the process for delivering functionality to be tested, according to the agreed upon schedule, of one or more component/application and/or system. Alternatively, for Artifact Type “Security Dependency”, a significant proportion of environment failures associated with qualifier values “Incorrectly Defined”, “Missing Elements”, “Reset or Restore”, and/or “Permissions Not Requested” may suggest weaknesses in process or skill/training. For Artifact Type “Security Dependency”, a significant proportion of environment failures associated with qualifier value “Requirement/Change Unknown/Not Documented” may imply communication deficiency. Alternatively, for Artifact Type “Security Dependency”, a significant proportion of environment failures associated with qualifier value “Confusing/Misleading Information” may suggest a weakness in usability of the component/system (e.g., in some form of documentation associated therewith).

For Artifact Type “Reboot/Restart/Recycle” both qualifier values mapped thereto may be associated with Component/System Focus Area. Frequent environment failures associated with this Artifact Type may imply a potentially serious deficiency in component/application maturity. In other words, during testing, if the system results in frequent reboots/restarts/recycles, individual components/applications with higher proportions of this Artifact Type may inadequately detect error conditions, address them or at least, report them and/or carry on without interruption. In this context, the system may only be as good as its weakest component. Consequently, the higher the proportion of immature components/applications in a system, the higher the risk of unsuccessfully completing test plans on schedule and of the system falling below an end user/customer acceptance level in production. Of the two qualifier values mapped to Artifact Type “Reboot/Restart/Recycle”, if “Diagnostics Inadequate” dominates, the component/application may be immature in terms of diagnostic capability, be in an earliest stage of development/release, and may disappoint end user expectation levels in production. Alternatively, if “Recoverability Inadequate” dominates, the component/application may likely provide adequate diagnostics, but may not have implemented sufficient recoverability to be able to correct the affected code, perform cleanup or repair, and continue. Consequently, the component/application may not meet end user expectations in production without future component/application enhancements focused on addressing recoverability. Additionally, if environment failures associated with either of the qualifier patterns identified above occurs, the improved DRM may examine an age of the component/application (e.g., to determine whether the component/application is introduced into the system for the first time with this release). Components/applications that are new to a system (e.g., with more significant maturity issues) may represent higher risk components, and consequently, such components/applications should receive higher attention to reduce risk.

For Artifact Type “Capacity”, a significant proportion of environment failures associated with qualifier values “Incorrectly Defined” and/or “Missing (Default Taken)” may indicate weaknesses in process or skill/training. Alternatively, for Artifact Type Capacity, a significant proportion of environment failures associated with qualifier “Confusing/Misleading Information” may suggest a weakness in terms of the usability of the Component or System (e.g., in some form of documentation associated therewith). Alternatively, for Artifact Type capacity, a significant proportion of environment failures associated with qualifier “Requirement/Change Unknown/Not Documented” may imply communication deficiency.

Further, for Artifact Type “Clear/Refresh”, a significant proportion of environment failures associated with qualifier value “Scheduled” (presently and/or relative to qualifier value “Unscheduled”) may imply a need to execute clear/refresh on some prescribed basis is documented and understood. Alternatively, for Artifact Type “Clear/Refresh”, a significant proportion of environment failures associated with qualifier value “Unscheduled” (presently and/or relative to qualifier value “Scheduled”) may imply that the clear/refresh is performed excessively, thereby indicating a weakness in a component/application in terms of cleanup and recovery.

Additionally, for Artifact Type “Maintenance”, a significant proportion of environment failures associated with qualifier value “Scheduled” (presently and/or relative to qualifier value “Unscheduled”) may imply that a need to perform Maintenance on some prescribed basis is documented and understood. Alternatively, for Artifact Type “Maintenance”, a significant proportion of environment failures associated with qualifier value “Unscheduled” (presently and/or relative to qualifier value “Scheduled may imply that maintenance had to be performed excessively, thereby indicating an excessive number of fixes are required for the component/application or system.

A third step of the DRM environment path is Trend Over Time Assessment. During Trend Over Time Assessment, the improved DRM may employ metric “Target=Environment by Open Date”. Such metric may be employed while assessing the interim progress and risk to determine if a trend of environment issues (e.g., failures) decreases over time. If the trend of environment issues overall does not decrease over time, additional variables such as those described below can yield significant insight into a level of risk posed to the schedule, testing effectiveness and corrective actions to reduce environment failures for the remainder of a test. When a testing environment closely mirrors a production environment, code testing may be more effective and a risk of moving to production may decrease. Additionally, when the testing environment closely mirrors the production environment, environment failures occurring in the testing environment may recur in production if not specifically addressed. Further, weaknesses exposed by this metric may introduce increased cost and delays if uncorrected, and therefore, such weaknesses should be scrutinized to evaluate risk posed to the schedule.

Additionally, such metric may be employed while assessing the phase exit risk to determine if the trend of overall environment issues (e.g., failures) decreases over time. If the trend of overall environment issues does not decrease over time, the improved DRM may employ one or more additional variable to yield significant insight. For example, a level of risk that adversely impacted testing effectiveness may be considered. When the testing environment closely mirrors the production environment, code testing may be more effective and risk of moving to production may decrease. Additionally, when the testing environment closely mirrors the production environment, environment failures occurring in the testing environment may recur in production if not specifically addressed. Further, when the testing environment exposes a weakness in usability and/or recoverability of components/applications or the system, customers may likely be affected by the same weakness when the system is released (e.g., in production). Also, during phase exit risk assessment, a determination of the potential seriousness of these failures may be made. Additionally, a determination may be made whether actions to reduce the failures can be taken.

Further, during Trend Over Time Assessment, the improved DRM may employ metric “Target=EnvSource by Open Date”. Such metric may be employed while assessing the interim progress and risk to determine a distribution of failures over time relative to components/applications. The distribution of failures over time relative to components/applications may reveal whether environmental failures are associated with one or more specific components, and whether these failures are pervasive over time during testing. Although the appearance of environment failures relative to a component/application may be expected to correspond with testing schedule focus on particular components/applications, a failure volume increase over time may indicate a component deficiency (e.g., diagnostic, recoverability and/or usability) or a testing organization skill weakness relative to particular components. Such environment failures may introduce cost to the project and jeopardize a testing schedule. Consequently, identifying and/or addressing risks of exposure to such failures early (e.g., as soon as one or more undesirable trends is revealed) may mitigate those risks.

Further, during Trend Over Time Assessment, the improved DRM may employ metric “Target=EnvSource by Open Date” while assessing the phase exit risk to determine a distribution of failures over time relative to components/applications. A significant volume of environmental failures associated with one or more specific components may represent a risk in the exit assessment because of a higher probability that testing of such components is less complete or effective than expected. Any component for which an environment failure trend is increasing over time may be error prone, and therefore, potentially cause problems, especially if such a trend continues during a final regression test within the phase. Once a component has been identified as error prone, an assessment of an Artifact Type and a Qualifier value associated therewith may reveal a specific nature of the deficiencies or failures, such as component deficiencies (e.g., diagnostic, recoverability, or usability) or testing organization skill weakness relative to particular components. Unless addressed such deficiencies or failures may pose similar risk exposure post production.

Further, during Trend Over Time Assessment, the improved DRM may employ metric “Target=EnvTrigger by Open Date”. Such metric may be employed while assessing interim progress and risk to determine a trend of trigger failures (e.g., simple coverage or variation triggers reflecting the simplest functions in the system) caused by environmental issues. For example, a simple trigger failure that originates due to an environmental issue, and increases or persists over time during testing may increase costs and jeopardize a testing schedule. A majority of simple triggers are expected to surface earlier in a test phase (than other trigger), and more complex triggers may occur later in the test phase (than other triggers). Therefore, the system is expected to stabilize in very basic ways early in testing, thereby allowing the testing organization to subsequently exercise the system in a more robust fashion as testing continues. In this way, the improved DRM may employ triggers to determine if system complexity is a factor influencing environment failures.

Further, during Trend Over Time Assessment, the improved DRM may employ metric “Target=EnvTrigger by Open Date” while assessing interim progress and risk to determine a trend of trigger failures caused by environmental issues. For example, a simple trigger failure that originates due to environmental issue, and increases or persists over time during testing may occur pervasively in similar frequencies in production if not specifically addressed. Thus the improved DRM may search for trends. For example, a trend of decreasing volume across most or all triggers may be expected by a last period preceding the exit assessment. Further, it is expected that a majority of simple triggers may surface earlier in the test phase (than other triggers) and more complex triggers may surface later (than other triggers). Therefore, the system is expected to stabilize in very basic ways early in testing, thereby allowing the testing organization to subsequently exercise the system in a more robust fashion as testing continues. Additionally, a complete absence of a phase/activity appropriate trigger may mean testing represented by that missing trigger was not performed, or if performed, was ineffective. If a volume of a trigger is significantly more than that expected, the component/application or system may have an unexpected weakness. Consequently, a trend over time may be examined to verify that the anomaly appeared early but was successfully addressed as testing progressed.

Further, during Trend Over Time Assessment, the improved DRM may employ metric “Target=Env Impact by Open Date”. Such metric may be employed while assessing interim progress and risk to determine an impact trend. The impact trend may indicate whether catastrophic environment failures are increasing over time (e.g., via the Reliability value of the Impact field), whether key basic system functions are impacted (e.g., via the Capability value of the Impact field), whether one or more components of the system may be configured into the system and may interact successfully (e.g., via the Interoperability/Integration value of the Impact field), whether the system is secured from intentional or unintentional tampering (e.g., via the Security value of the Impact field), whether a speed of transactions meets specifications (e.g., via the Performance value of the Impact field) and/or whether an ease of use deficiency has a detrimental effect on cost and scheduling (e.g., the Installability, Maintenance, Serviceability, Migration, Documentation and Usability value of the Impact field).

Additionally, in a similar manner, such metric may be employed while assessing the phase exit risk to determine an impact trend. If impacts that relate to reliability occur persistently over time, especially near an exit of testing, and the production environment closely mirrors the testing environment, the system may include a fundamental instability that may reduce end-user/customer satisfaction with the system.

A fourth step may include DRM Environment Artifact Analysis which includes System Stability Assessment. During assessment of system stability, the improved DRM may employ metric “Target=Env Artifact Type by Severity”. Such metric may be employed while assessing the interim progress and risk to determine a severity associated with environment failures associated with an Artifact type. For high frequency failures associated with an Artifact type, severity may be employed to prioritize focus areas and associated actions. In this manner, the metric may be employed to understand a significance of environmental failures that may be avoidable if an environmental build or maintenance process/set of procedures may receive a higher (e.g., extra) focus. Additionally, such metric may be employed to weigh a cost of providing that extra focus (e.g., assigning a high vs. a low severity) against the impact of the failures. In a similar manner, during System Stability Assessment, the improved DRM may consider the above indicators to assess a Future Improvement of the software project.

Further, during System Stability Assessment, the improved DRM may consider the above indicators to assess a Phase Exit Risk of the software project. For high frequency Artifact types, severity may be useful in prioritizing focus areas and associated actions. Understanding a significance of environmental failures that are likely to be manifested in production, and weigh the cost of providing that extra focus against the impact of the failures (e.g., assigning a high vs. a low severity).

Further, during System Stability Assessment, the improved DRM may employ metric “Target=Env Artifact Type by Impact”. Such metric may be employed to understand the impact of environment failures on a system while assessing an interim progress and risk, a phase exit risk and/or future improvements. For example, such a metric may be employed while assessing interim progress and risk to determine an impact trend. The impact trend may indicate whether catastrophic environment failures are increasing over time (e.g., via the Reliability value of the Impact field), whether key basic system functions are impacted (e.g., via the Capability value of the Impact field), whether one or more components of the system may be configured into the system and may interact successfully (e.g., via the Interoperability/Integration value of the Impact field), whether the system is secured from intentional or unintentional tampering (e.g., via the Security value of the Impact field), whether a speed of transactions meets specifications (e.g., via the Performance value of the Impact field) and/or whether an ease of use deficiency has a detrimental effect on cost and scheduling (e.g., via the Installability, Maintenance, Serviceability, Migration, Documentation and Usability value of the Impact field).

Further, during System Stability Assessment, the improved DRM may employ metric “Target=Env Artifact Type by Trigger”. Such a metric may be employed while assessing the phase exit risk to understand the nature of environment failures as they relate to increasing complexity in the nature of the tests being performed. For example, if simple system function triggers cluster in significant relative frequencies, the overall detailed system design (e.g., in terms of code and/or environment) may not be stable and/or well understood/interlocked/executed. Additionally, the overall system hardware and/or the software integration design, particularly with respect to performance/capacity may require additional focus and/or revision. A high risk may be associated with moving a system exhibiting this pattern to production. Consequently, hardware upgrades and/or replacements may be necessary to produce a reliable production system. Further, if the more complex triggers cluster in significant relative frequencies, the system may be stable from a basic perspective. However, more complex and advanced systems may include deficiencies in process, skill/training, component (e.g., diagnostic capability, recoverability, usability) and/or communication across components. When evaluating risk at exit, a user may determine whether these complex scenarios may be encountered (e.g., based on a maturity of the system and potential customer usage).

Additionally, such a metric may be employed while assessing future improvements to understand the nature of environment failures as they relate to increasing complexity in the nature of the tests being performed. For example, if simple system function triggers cluster in significant relative frequencies, the overall detailed system design (e.g., in terms of code and/or environment) may not be stable and/or well understood/interlocked/executed. Additionally, the overall system hardware and/or the software integration design, particularly with respect to performance/capacity may require additional focus and/or revision. Consequently, focusing attention on preventive actions when simple triggers dominate should be a high priority. Further, if more complex triggers cluster in significant relative frequencies, the system may be stable from a basic perspective. However, more complex and advanced systems may include deficiencies in process, skill/training, component (e.g., diagnostic capability, recoverability, usability) and/or communication across components. System maturity and potential customer usage may be considered to evaluate when these complex scenarios will likely be encountered, and based thereon, whether actions to prevent such scenarios should be of a high priority.

The improved DRM may overcome disadvantages of the conventional methodology. For example, a defect analysis methodology known as Orthogonal Defect Classification (ODC), which was developed by the assignee of the present invention, IBM Corporation of Armonk, N.Y., exists. ODC is a complex but effective quality assessment schema for understanding code-related defects uncovered in test efforts. However, ODC like other similar software testing quality assessment techniques (e.g., the “effort/outcome framework”) tends to be complex, and in its current form, is incapable of addressing a number of the practical realities of a software development product to market lifecycle, which require more than just an understanding of the quality of the code. Further, other models, like Boehm's 2001 COCOMO schema, or the Rational Unified Process (RUP) rely on even more generalized techniques for understanding system quality with respect to risk decision making. However, today there is no “one size fits all” model that has broad applicability across any kind of function or system oriented test effort.

A key shortcoming of all of these models, including ODC, is the focus of assessment metrics and effort exclusively on the code. Focusing on understanding general daily “execution rates” (e.g., a number of test cases executed relative to a number of cases attempted) particularly at the test case rather than step level provides at best a diluted understanding of code quality because a test case or step can fail for a variety of reasons that may or may not relate back to the code itself. For example, defects in test can and in reality, frequently do, occur due to data or environment problems. Additionally, defects that ultimately turn out to be invalid for some reason (e.g., duplicate defect, tester error, working as designed and/or the like) may also adversely impact that execution rate, and thus, the perception of the code quality.

Further, Root Cause analysis does not provide any additional meaningful understanding, as such methodology simply considers a frequency by which a given cause occurs, usually calculated only at or after the end of the test. Hence, such methodology is not only too slow to be very effective but also only capable of rudimentary analysis (e.g., typically provides a single set of x/y axis charts or relative distribution pie graphs). Therefore, Root Cause models do not propose any solutions or actions teams can take to find defects earlier in the project lifecycle to reduce overall costs or otherwise improve/reduce future defect rates. While existing ODC does provide insight on actions/solutions, such ODC is currently limited to guidance on achieving code quality, with no substantive direction provided for how to similarly gain insight on actions/solutions for ensuring environment quality/assessing environment risk in test.

In contrast to Root Cause Analysis, for example, the improved ODC (e.g., improved DRM) described above is a multidimensional model. Rather than evaluating a single attribute of a defect, the improved DRM looks at specific factors relating to both the cause of the defect as well as how the defect was found, regardless of whether the defect/failure is found to be due to code, environment or related to data. Further, in contrast to Root Cause analysis, the improved DRM does not rely only on total frequencies of these variables at the end of the test phase, but also the distribution of those frequencies as they occur over time during the test cycle. The trends over time of these variables may yield a multifaceted analysis which may produce significant and precise insight into key focus areas, project risk moving forward, test effectiveness, testing efficiency, customer satisfaction, and the readiness of a system to move to production.

The improved DRM compares favorably to existing ODC. For example, ODC is limited to code quality actionable information. Therefore, ODC is an incomplete model without an extension of the schema to environment failures. The existing ODC is incapable of providing meaningful insight into the impact and correction of environmental failures in all test efforts. Therefore, the improved DRM is the only comprehensive model yielding precise, actionable information across both defects and environment failures to large development/integration project customers. Defects attributed to environmental issues can be significant and add unnecessary cost to testing projects. In addition, environment failures inhibit the overall effectiveness of the testing effort because they take resource effort away from the main focus of the test effort. Time to market factors make schedule extension prohibitively risky and expensive, so projects suffering from significant environment failures in test will ultimately yield lower quality/higher risk systems that are not cost effective to test. Therefore, preventing/reducing environmental failures is an effective strategy to reduce business costs, both in terms of more efficient/effective software system testing as well as a higher quality/less expensive software system in production to maintain. Consequently, the improved DRM may have extremely broad market applicability and may be extremely valuable to software system engineering (e.g., any development/software integration project) across all industries. The improved DRM may include a set of definitions, criteria, processes, procedures and/or reports to produce a comprehensive assessment model tailored for understanding (1) in progress quality/risks (2) exit quality/risks and (3) future recommended actions of environment failures in testing projects. The present methods and apparatus include the definition schema, criteria, process, procedures and reports created for environment failures in software system testing that are included in the improved DRM. In this manner, the improved DRM may make ODC based classification and assessment information applicable to environment failures in software system testing.

The foregoing description discloses only exemplary embodiments of the invention. Modifications of the above disclosed apparatus and methods which fall within the scope of the invention will be readily apparent to those of ordinary skill in the art. For instance, supporting reports illustrating the metrics shown above can be created using the ad hoc reporting feature within the defect data analysis tool (e.g., JMYSTIQ analysis tool). Further, supporting deployment processes for improved DRM may be provided with and/or included within the improved DRM in a manner similar to that described in U.S. patent application Ser. No. 11/122,799, filed on May 5, 2005 and titled “METHODS AND APPARATUS FOR DEFECT REDUCTION ANALYSIS” (Attorney Docket No. ROC920040327US1).

Accordingly, while the present invention has been disclosed in connection with exemplary embodiments thereof, it should be understood that other embodiments may fall within the spirit and scope of the invention, as defined by the following claims.

The invention claimed is:

1. A defect analysis method, comprising:
while testing a software project, identifying at least one failure caused by an environment of the project; and
considering the effect of the project environment on the software project while analyzing the failure.

2. The method of claim 1 wherein considering the effect of the project environment on the software project while analyzing the failure includes considering the effect of the environment on the software project while performing orthogonal defect classification (ODC).

3. The method of claim 1 further comprising generating a report based on results of analyzing the failure.

4. The method of claim 1 wherein considering the effect of the project environment on the software project while analyzing the failure includes employing at least one project environment metric.

5. The method of claim 4 wherein employing at least one project environment metric includes at least one of considering a trend over time of the metric and considering a total frequency of the metric.

6. The method of claim 1 further comprising assessing the impact of the failure on the software project based on the failure analysis.

7. The method of claim 1 further comprising reducing maintenance of the software project.

8. An apparatus, comprising:
an ODC analysis tool; and
a database coupled to the ODC analysis tool and structured to be accessible by the ODC analysis tool;
wherein the apparatus is adapted to:
receive data including at least one failure caused by an environment of a software project, the failure identified while testing the software project; and
consider the effect of the project environment on the software project while analyzing the failure.

9. The apparatus of claim 8 wherein the apparatus is further adapted to consider the effect of the environment on the software project while performing orthogonal defect classification (ODC).

10. The apparatus of claim 8 wherein the apparatus is further adapted to generate a report based on results of analyzing the failure.

11. The apparatus of claim 8 wherein the apparatus is further adapted to employ at least one project environment metric.

12. The apparatus of claim 11 wherein the apparatus is further adapted to at least one of consider a trend over time of the metric and consider a total frequency of the metric.

13. The apparatus of claim 8 wherein the apparatus is further adapted to assess the impact of the failure on the software project based on the failure analysis.

14. The apparatus of claim 8 wherein the apparatus is further adapted to reduce maintenance of the software project.

15. A system, comprising:
a defect data collection tool;
an ODC analysis tool; and
a database coupled to the defect data collection tool and the ODC analysis tool and structured to be accessible by the ODC analysis tool;
wherein the system is adapted to:
receive in the database from the defect data collection tool data including at least one failure caused by an environment of a software project, the failure identified while testing the software project; and
consider the effect of the project environment on the software project while analyzing the failure.

16. The system of claim 15 wherein the system is further adapted to consider the effect of the environment on the software project while performing orthogonal defect classification (ODC).

17. The system of claim 15 wherein the system is further adapted to generate a report based on results of analyzing the failure.

18. The system of claim 15 wherein the system is further adapted to employ at least one project environment metric.

19. The system of claim 18 wherein the system is further adapted to at least one of consider a trend over time of the metric and consider a total frequency of the metric.

20. The system of claim 15 wherein the system is further adapted to assess the impact of the failure on the software project based on the failure analysis.
